(19) United States
(12) Patent Application Publication
(10) Pub. No.: US 2008/0001811 A1
(43) Pub. Date: Jan. 3, 2008

(54) Digital broadcasting receiver having location registration and notification function and method using the same

(75) Inventor: Seong Geun Kwon, Daegu Metropolitan City (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/807,978

(22) Filed: May 31, 2007

(30) Foreign Application Priority Data
Jun. 19, 2006 (KR) 10-2006-0054949

(51) Int. Cl. G01S 1/00; H04B 7/185

(52) U.S. Cl. 342/352; 342/385

(57) ABSTRACT

A digital broadcasting receiver having a location registration and notification function is disclosed. The receiver includes a receiving unit for receiving data including identification information of a gap filler; an input unit for inputting a location registration request signal; a sub-controller for detecting gap filler identification information (GFID) from the digital broadcasting data; a main controller for creating location identification information corresponding to the GFID in response to the location registration request signal; and a location information storage unit for storing the GFID and the location identification information.

### PRIORITY

This application claims priority to an application entitled “DIGITAL BROADCASTING RECEIVER HAVING LOCATION REGISTRATION AND NOTIFICATION FUNCTION, AND REGISTRATION AND NOTIFCATION METHOD USING THE SAME” filed in the Korean Intellectual Property Office on Jun. 19, 2006 and assigned Serial No. 2006-0054949, the contents of which are incorporated herein by reference.

### BACKGROUND OF THE INVENTION

1. Field of the Invention

The present invention relates to a digital broadcasting receiver, and more particularly, to a digital broadcasting receiver and a notification/registration method, which registers location based on the identification information of gap fillers in a satellite broadcasting system, and notifies users of the registered location.

2. Description of the Related Art

With the development of mobile communication technology, mobile communication terminals, such as a mobile phone, a Personal Digital Assistant (PDA), a laptop computer, etc., are widely used, and their functions are becoming more varied. For example, the early mobile phone could only perform voice communication, but the current mobile phone can perform text and image messaging, etc. etc.

Also, recently, wireless Internet services provide services through a wireless communication network. Such wireless Internet services provide information to mobile communication service subscribers via a wireless communication network. The information, which includes news, weather, sports, stock prices, exchange rates, traffic information, etc., is provided as text, voice message, and still and moving images.

Specifically, location-based services (LBS) of the wireless Internet services have been given a lot of attention due to their wide availability and convenience. The LBS are communication services that use knowledge about the location of mobile communication terminals, such as a mobile phone, a Personal Digital Assistant (PDA), a laptop computer, etc., and provide additional information related to the location, such as local information.

However, the location-based service employs a map or geographic information, which is commonly provided to the public. That is, the services cannot provide users with specific information that the users individually desire. For example, the services cannot provide a user with specific information on a place that the user desires to remember (i.e., an individually commemorative place or an individually memorable place), although the place was not registered on an electronic map.

### SUMMARY OF THE INVENTION

In order to solve the above problems, an object of the present invention is to provide a method and apparatus for providing information of an individually commemorative or memorable place, although the place was not registered in an electronic map.

It is another object of the present invention to provide a method and apparatus for allowing users to register their specific locations.

It is yet another object of the present invention to provide a method and apparatus for using the information previously registered by users to provide information of corresponding places, when the users access the registered location.

In accordance with an aspect of the present invention, the above and other objects can be accomplished by the provision of a digital broadcasting receiver including a receiving unit for receiving digital broadcasting data including identification information of a gap filler that repeats the digital broadcasting data transmitted from a satellite; an input unit for inputting a location registration request signal; a sub-controller for detecting gap filler identification information (GFID) from the digital broadcasting data; a main controller for creating location identification information corresponding to the GFID in response to the location registration request signal; and a location information storage unit for storing the GFID and the location identification information.

Preferably, the main controller requests input of location information corresponding to the GFID, matches the location information with the GFID when the location information is inputted in response to the request, and then stores the matching result in the location information storage unit.

Preferably, the receiver may further include an output unit for outputting location information stored in the location information storage unit.

Preferably, the output unit includes a display unit for displaying the location information as image or text; a speaker for outputting the location information. Preferably, the main controller makes a determination as to whether location information corresponding to the GFID detected by the sub-controller is in the location information storage unit, reads the location information from the location information storage unit when the determination is positive, and outputs the location information through the output unit.

Preferably, the sub-controller previously stores GFID storing field information of the digital broadcasting data, and detects GFID based on the field information.

Preferably, the receiver is installed to a mobile phone or a personal digital assistant (PDA).

In accordance with another aspect of the present invention, the above and other objects can be accomplished by the provision of a method for providing a location information registration including receiving digital broadcasting data including identification information of a gap filler; detecting gap filler identification information (GFID) from the digital broadcasting data; creating location identification information corresponding to the GFID in response to a location registration request signal; storing location information including the GFID and the location identification information; and registering the location information including the GFID and the location identification information.

In accordance with anther aspect of the present invention, the above and other objects can be accomplished by the provision of a method for providing a location information notification including detecting gap filler identification information (GFID) in data received from a filter; detecting previously stored location information corresponding to the GFID; and outputting the detected location information.

Preferably, the step of detecting GFID is performed based on GFID storing field information previously stored.

Preferably, the step of storing location information includes requesting input of location information corresponding to the GFID; and when the location information is inputted, matching the location information with the GFID and storing the matching result.

Preferably, the step of outputting a location information notification signal includes when the GFID is detected from the DMG data, determining as to whether location information corresponding to the GIFD is previously stored; reading the location information when the determination is positive; and outputting the location information.

Preferably, the outputting step displays the location information as image or text or outputs the location information as voice or audio.

Preferably, the step of detecting gap filler identification information includes checking an area including the GFID in digital broadcasting data transmitted from a satellite; and detecting the GFID based on the checking result.

### BRIEF DESCRIPTION OF THE DRAWINGS

The above object, features, and advantages of the present invention will be more apparent from the following detailed description in conjunction with the accompanying drawings, in which:

FIG. 1 is a system overview illustrating the configuration of a digital broadcasting system according to the present invention;

FIG. 2 is a block diagram of a digital broadcasting receiver according to the present invention;

FIG. 3 shows the format of digital broadcasting data format transmitted to the DMB receiver of FIG. 2;

FIG. 4 shows the structure of the database for administrating information necessary to administrate location information, according to the present invention;

FIG. 5 is a flowchart describing the method for registering location according to the present invention; and

FIG. 6 is a flowchart describing the method for providing location notification according to the present invention.

### DETAILED DESCRIPTION OF PREFERRED EMBODIMENTS

Hereinafter, embodiments of the present invention are described in detail with reference to the accompanying drawings. In the drawings, the same or similar elements are denoted by the same reference numerals even though they are depicted in different drawings. In the following description, detailed description of known functions and configurations incorporated herein will be omitted when it may obscure the present invention.

Digital Broadcasting refers to broadcasting services where various multimedia signals, such as, voice, images, etc., are digitally modulated and then provided to users. In particular, the digital broadcasting allows users even while moving to access various types of broadcasting through a personal portable receiver or a receiver for vehicles, which has an omni-directional receiving antenna.

On the other hand, as loading technology for memory capable of storing a large amount of digital multimedia (for example, moving images, music video, etc.) becomes available and mobile communication terminals are more and more in demand, new mobile communication terminals that can receive digital broadcasting data have been developed and are available to be purchased.

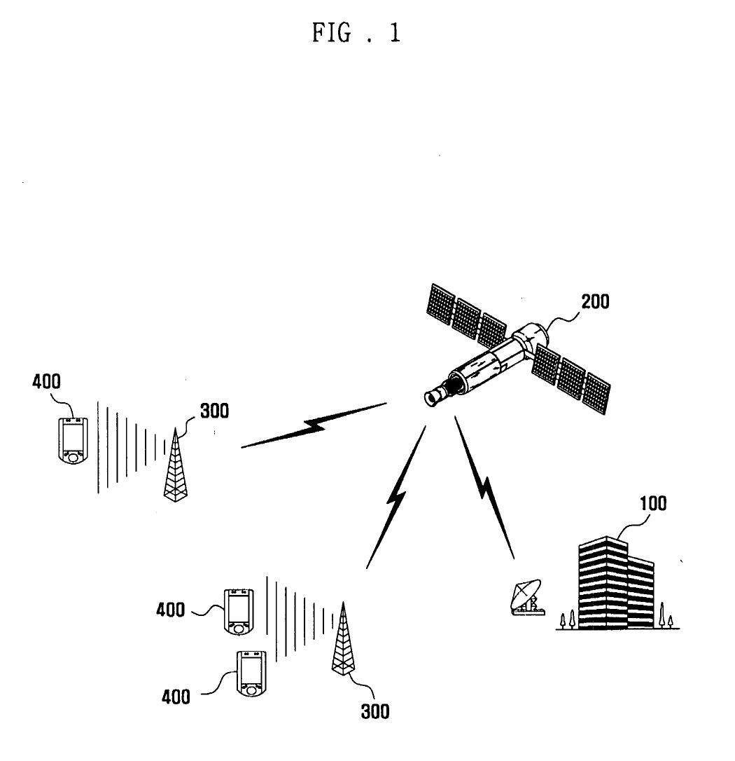

Referring to FIG. 1, the S-digital broadcasting system includes a broadcasting station 100, a digital broadcasting satellite 200, a gap filler 300, and digital broadcasting receivers 400.

Broadcasting station 100 creates various broadcasting signals (14 GHz) for moving images, music videos, and television shows, etc., and transmits them to digital broadcasting satellite 200.

Digital broadcasting satellite 200 receives the broadcasting signals (14 GHz) from broadcasting station 100 and transmits the broadcasting signals, whose bandwidth is 2.6 GHz or 14 GHz, to the earth.

Gap filler 300 receives the broadcasting signals whose bandwidth of 14 GHz from digital broadcasting satellite 200, and then outputs broadcasting signals whose bandwidth of 2.6 GHz. Gap filler 300 inserts gap filler ID (hereinafter, referred to as GFID) to a specific region of the received broadcasting signals from digital broadcasting satellite 200 and then outputs the broadcasting signals including the GFID. The GFID is inherent to each gap filler. That is, each gap filler has different GFID.

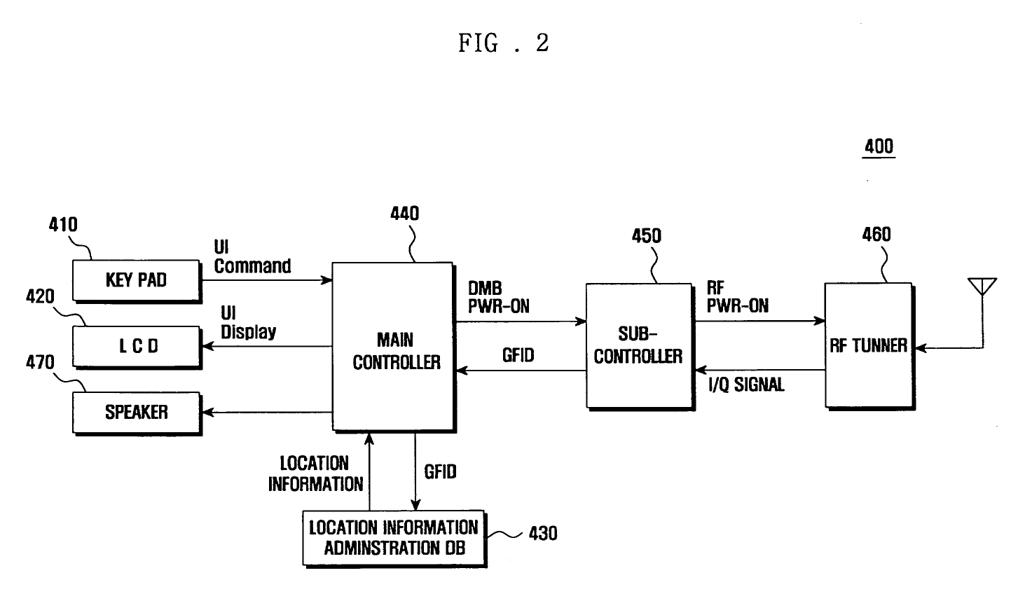

Digital broadcasting receiver 400 receives the broadcasting signals, whose bandwidth is 2.6 GHz, from digital broadcasting satellite 200 or gap fillers 300. Specifically, Digital broadcasting receiver 400 registers its location, based on the GFID included in the broadcasting signals transmitted from gap filler 300 and based on user input information corresponding to the GFID. And, digital broadcasting receiver 400 provides information corresponding to a location based on the registration information. For example, digital broadcasting receiver 400 matches the GFID, included in the received broadcasting signal, with user input information corresponding to the GFID, and then stores them in a database. When visiting the location again, digital broadcasting receiver 400 provides information of the corresponding location based on information stored in the database. That is, the location information inputted by a user is provided so that the user can recall the location. Digital broadcasting receiver 400 is preferably configured as a mobile communication terminal, such as a mobile phone or a PDA, etc. The configuration of digital broadcasting receiver 400 is shown in FIG. 2.

Referring to FIG. 2, digital broadcasting receiver 400 includes a keypad 410, an LCD 420, a location information administration database (DB 430), a main controller 440, a sub-controller 450, an RF tuner 460, and a speaker 470.

Keypad 410 inputs a user input (UI) command for controlling digital broadcasting receiver 400 and then transmits it to main controller 440. Specifically, keypad 410 inputs a location registration request signal and then transmits it to main controller 440.

LCD 420 displays a variety of information related to operations of digital broadcasting receiver 400 according to the control of main controller 440. Specifically, LCD 420 displays digital broadcasting data, received through RF tuner 460, according to the control of main controller 440. Also, LCD 420 displays surrounding location information of a place where digital broadcasting receiver 400 is located and the location information of the place.

Location information administration DB 430 stores location information where the respective gap fillers are installed. Specially, it is preferable that location information administration DB 430 stores identification information from a gap filler at a place (a point) where a user requests location registration and location identification information of the place (for example, to indicate that the place has already been registered by the user). Such a process is provided to enable digital broadcasting receiver 400 to remind the user that the place has already been registered when the user visits the place again.

That is, when the user registers a point (i.e., a place) on location information administration DB 430 and then visits the place again, main controller 440 notifies the user that the place has already been registered based on the information stored in location information administration DB 430. For example, “THIS PLACE HAS ALREADY BEEN REGISTERED” is displayed on LCD 420 or outputted through speaker 470.

When a user inputs specific information (for example, the place where the user has met Friend 1 or the place where a police car is always on standby) as location information, location information administration DB 430 matches the GFID to display the place with the specific information and stores it therein. In this case, main controller 440 provides the information corresponding to the location based on the input information. For example, “THE PLACE WHERE I MET FRIEND 1 OR THE PLACE WHERE A POLICE CAR IS ALWAYS ON STANDBY” is displayed on LCD 420 or output through speaker 470.

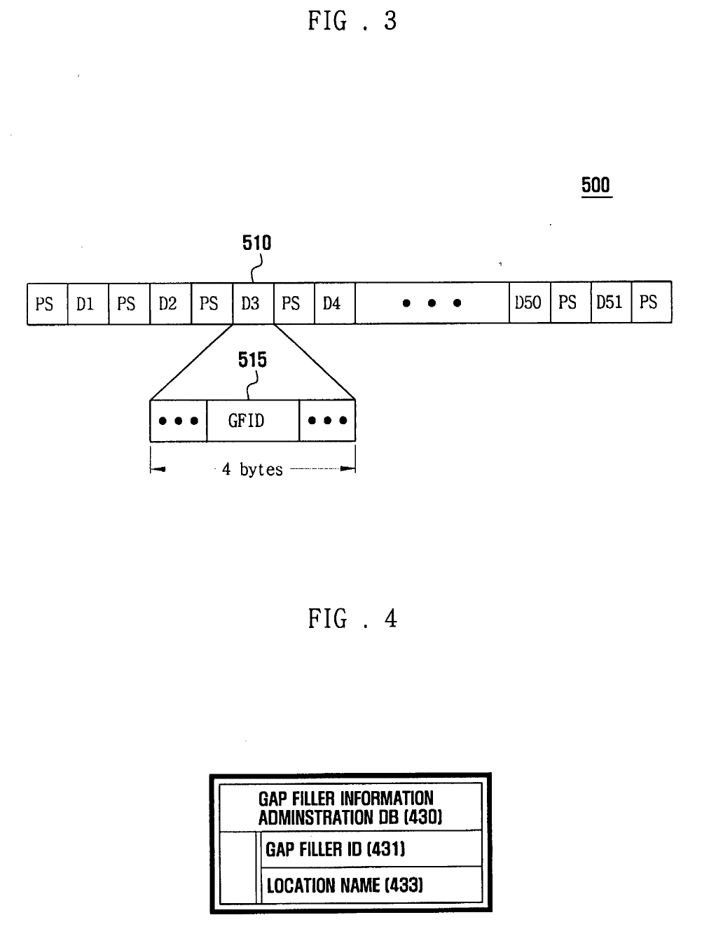

An exemplary of the structure of location information administration DB 430 is shown in FIG. 4, and will be now be explained.

Main controller 440 controls operations of digital broadcasting receiver 400 by, for example, a UI command, inputted through keypad 410, or a previously stored control algorithm. Specially, main controller 440 controls the ON/OFF operations of sub-controller 450 based on user request information inputted through keypad 410.

Also, after inputting a GFID from sub-controller 450, main controller 440 registers a location in location information administration DB 430, based on the GFID, or searches DB 430 to output a location notification signal. When a location registration request signal is inputted through keypad 410, main controller 440 creates location identification information corresponding to the GFID transmitted from sub-controller 450 in response to the inputted location registration request signal, and then stores it in location information administration DB 430. For example, main controller 440 creates the location identification information (for example, to indicate that the place has already been registered) corresponding to the GFID transmitted from sub-controller 450 at the time when inputting the location registration request signal, and then stores the location identification information and the GFID in location information administration DB 430.

In response to the location registration request signal, main controller 440 stores the GFID transmitted from sub-controller 450, and then requests an input of the location information corresponding to the GFID. In response to the request, when the location information (for example, the place where the user has met Friend 1 or the place where a police car is always on standby, etc.) is input, it is preferable that the location information matches the GFID and then the result is stored in the location information storage unit.

After completing the registration, when the GFID is transmitted from sub-controller 450 to main controller 440, not in a location registration mode, main controller 440 makes a determination as to whether the location information corresponding to the GFID was stored in location information administration DB 430. When the determination is positive, main controller 440 performs control in such a way that the location information is read from location information administration DB 430 and then output. For example, main controller 440 performs control in such a way that an image or text is created from the location information to output it through LCD 420 or voice or audio is created to output it through speaker 470.

Sub-controller 450, also referred to as a digital broadcasting chip, is activated in response to a d power control signal, digital broadcasting PWR-ON, transmitted from main controller 440, and turns on RF tuner 460 to receive DMB data. To this end, sub-controller 450 transmits an RF power control signal, RF PWR-ON, to RF tuner 460. When sub-controller 450 inputs an I/Q signal including digital broadcasting data from RF tuner 460, it is preferable that sub-controller 450 detects a GFID from the I/Q signal and transmits it to main controller 440. It is especially preferable that, from a pilot channel received by RF tuner 460, sub-controller 450 detects the ID of a gap filler (i.e., GFID) that transmits the pilot channel, and then transmits it to main controller 440. Such an operation is performed so that main controller 440 can register a location corresponding to the GFID or detect previously stored location information. To this end, it is preferable that sub-controller 450 stores GFID field information (i.e., storage location of GFID) within the pilot channel and detects the GFID using the field information.

RF tuner 460 is activated in response to the RF tuner power control signal, RF PWR-ON, transmitted from sub-controller 450 to receive digital broadcasting data, and then transmits the received digital broadcasting data to sub-controller 450. Here, the received digital broadcasting data includes identification information for repeating digital broadcasting data transmitted from a satellite.

Preferably, the digital broadcasting receiver according to the present invention is installed in a mobile phone or a PDA.

FIG. 3 shows a frame of digital broadcasting data 500. Referring to FIG. 3, digital broadcasting data 500 is configured to include a pilot symbol PS of 32 bits and satellite broadcasting control data D1˜D51 each having 32 bits, in which the pilot symbol and the satellite broadcasting control data are alternatively aligned. Here, the pilot symbol is configured in such a way that all its data is ‘1.’ Of the satellite broadcasting control data, ‘D1’ denotes a unit word, ‘D2’ denotes a frame counter, and ‘D3˜D50’ denote control data for the broadcasting channel. Also, D51 denotes a reserved control data area and does not store any data.

DMB data 500, configured as described above, stores various control information and channel information using the divided data areas.

Thus, the gap filler stores a GFID in one of the data areas, in which data is not stored, and then transmits it to the digital broadcasting receiver. Generally, the gap filler inserts the GFID into the upper 4 bytes of data area ‘D3’ of digital broadcasting data 500, labeled as 510 in FIG. 3. Also, the gap filler may insert the GFID into the area D51 in which data is not stored.

Thus, to detect the GFID in digital broadcasting data 500, it is preferable that sub-controller 450 of FIG. 2 first stores information concerning which area of digital broadcasting data 500 the GFID is stored in, and then detects the GFID in the area.

Referring to FIG. 4, location information administration DB 430 includes a gap filler ID field 431 and a location name field 433.

Gap filler ID field 431 stores a gap filler identification number, and location name field 433 stores the name of a corresponding location or location identification information. Here, the location identification information is preferably specific information inputted by the user.

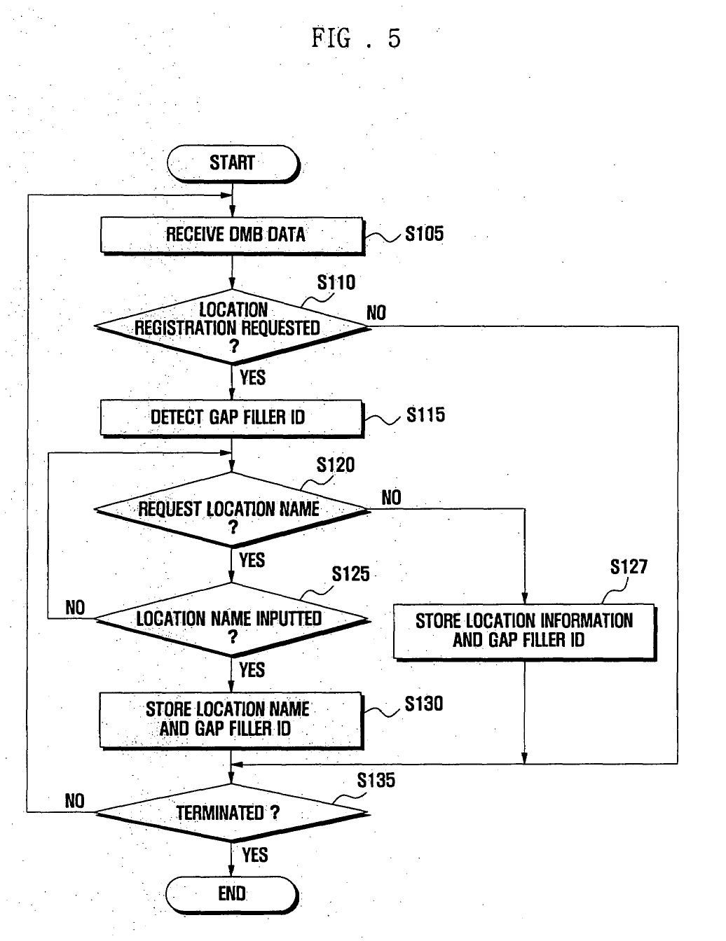

Referring to FIGS. 2 and 5, main controller 440 controls sub-controller 450 to receive digital broadcasting data through RF tuner 460 in step S105. Here, the received digital broadcasting data includes gap filler identification information. When a location registration request signal is inputted through keypad 410 in step S110, sub-controller 450 detects the gap filler identification information from the received digital broadcasting data in step S115. Here, it is preferable that sub-controller 450 previously stores storage field information of the GFID, and detects GFID using the field information.

After that, the detected GFID is transmitted to main controller 440. Then, main controller 440 requires a user to input a location name corresponding to the GFID in step S120. When the location name is inputted in step S125, the location name and the GFID detected in the above step S115 are stored in location information administration DB 430 in step S130. When a termination request is input in step S135, the procedure is terminated.

Here, the steps S120, 125 of inputting the name of the location to be registered are optional. That is, when the user inputs a location name, the inputted location name is stored together with the GFID. On the other hand, when the location is not inputted, it is preferable that the GFID and identification information (for example, a serial number, etc.) for the location are stored in step s127.

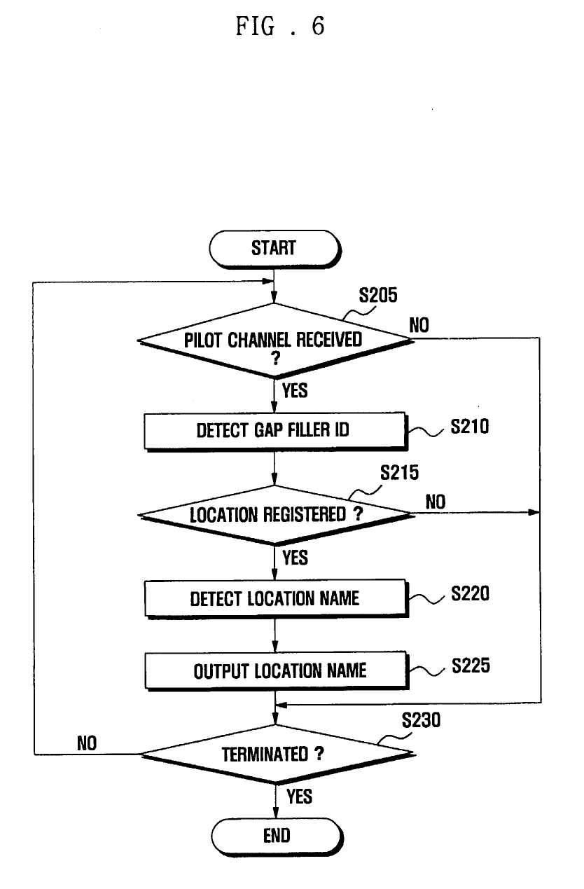

Referring to FIGS. 2 and 6, when digital broadcasting data including a pilot channel is received by RF tuner 460 in step S205, sub-controller 450 analyzes the digital broadcasting data to detect identification information of a gap filler (i.e., GFID) that transmits pilot channel in step S210. After that, the detection result is transmitted to main controller 440.

Main controller 440 makes a determination as to whether a location corresponding to the GFID is registered in step S215. To this end, main controller 440 searches location information administration DB 430 based on the GFID. When the determination is positive, main controller 440 is implemented in such a way to determine that the location corresponding to the GFID is registered. On the other hand, when the determination is negative, main controller 440 is implemented in such a way to determine that the location corresponding to the GFID is not registered.

From the determination in step S215, when the location corresponding to the GFID is registered, main controller 440 detects a location name corresponding to the GFID from location information administration DB 430 in step S220. Here, the location name is information to identify a corresponding location, preferably a specific name or user's inputted information.

After that, main controller 440 outputs the detected location name in step S225, through at least one of speaker 470 and LCD 420, for example. Specifically, main controller 440 creates text or image data from the location name to display it on LCD 420. Main controller 440 also creates voice or audio data from the location name to output through speaker 470.

FIG. 6 shows an exemplary embodiment that detects and outputs location names previously stored based on GFIDs. However, the present invention is not limited to storing location names based on GFIDs. That is, as the same location identification information is inputted based on the GFIDs, all locations where GFID is registered can be commonly administrated. Since a sentence, not a specific name, based on GFIDs can be input, individual commemoration or memorable information can be administrated.

As described in the foregoing, as the digital broadcasting receiver of the present invention registers location using satellite broadcasting GFID and notifies a user of the registered location, it provides information of a place that a user should individually commemorate or memorize. In addition, the present invention collectively registers many pieces of location information (for example, a traffic safety zone, etc.), which a user wants to individually administer, and performs a location notification using the information.

While the present invention has been shown and described in detail with reference to embodiments thereof, it will be understood by those of ordinary skill in the art that various changes in form and detail may be made therein without departing from the spirit and scope of the present invention as further defined by the following claims.

What is claimed is:

1. A digital broadcasting receiver comprising:
a receiving unit for receiving data including identification information of a gap filler;
an input unit for inputting a location registration request signal;
a sub-controller for detecting gap filler identification information (GFID) from the data;
a main controller for creating location identification information corresponding to the GFID in response to the location registration request signal; and
a location information storage unit for storing the GFID and the location identification information.

2. The digital broadcasting receiver of claim 1, wherein the main controller requests input of location information corresponding to the GFID, matches the location information with the GFID when the location information is inputting response to the request, and then stores the matching result in the location information storage unit.

3. The digital broadcasting receiver of claim 1, further comprising an output unit for outputting location information stored in the location information storage unit.

4. The digital broadcasting receiver of claim 3, wherein the output unit comprises:
a display unit for displaying the location information as one of image and text;
a speaker for outputting the location information as voice or audio.

5. The digital broadcasting receiver of claim 3, wherein the main controller makes a determination as to whether location information corresponding to the GFID detected by the sub-controller is in the location information storage unit, reads the location information from the location information storage unit when the determination is positive, and outputs the location information through the output unit.

6. The digital broadcasting receiver of claim 1, wherein the sub-controller previously stores GFID storing field information of the data, and detects GFID based on the field information.

7. The digital broadcasting receiver of claim 1, wherein the receiving is installed in a wireless communication device.

8. The digital broadcasting receiver of claim 1, wherein the receiver receives data including the gap filler identification (GFID) information in digital broadcast data transmitted from a satellite.

9. A method for providing a location information notification comprising:
detecting gap filler identification information (GFID) in data received from a filler;
detecting previously stored location information corresponding to the GFID;
and outputting the detected location information.

10. The method of claim 9, wherein the step of detecting GFID is performed based on GFID field information previously stored.

11. The method of claim 9, further comprising:
Storing the location information,
wherein storing the location information comprise requesting input of location information corresponding to the GFID; and matching the location information with the GFID and storing the matching result when the location information is input.

12. The method of claim 9, wherein the outputting displays the location information as one of image and text, or outputs the location information as one of voice and audio.

13. The method of claim 9, wherein the detecting gap filler identification information comprises:
checking an area including the GFID in digital broadcasting data transmitted from a satellite; and
detecting the GFID based on the checking result.

14. The method of claim 9, wherein the detecting gap filler identification information comprises:
creating a pilot channel between a digital broadcasting receiver and the filler; and
detecting identification information of the filler that transmits the pilot channel.

15. A method for registering location information comprising:
receiving data including gap filler identification information form a filler;
detecting the gap filler identification information from the data;
creating location identification information corresponding to the gap filler identification information in response to a location registration request signal; and
storing location information including the gap filler identification information and the location identification information.

16. The method of claim 15, wherein detecting the gap filler identification information is performed based on gap filler identification information storing field information that is previously stored.

17. The method of claim 15, wherein detecting gap filler identification information comprises:
checking an area including the GFID in digital broadcasting data transmitted from a satellite; and
detecting the GFID based on the checking result.
